(19) United States
(12) Patent Application Publication
(10) Pub. No.: US 2025/0258721 A1
(43) Pub. Date: Aug. 14, 2025

(54) WEIGHTED ROUND ROBIN BUS ARBITRATION WITH CONTROL VECTORS AND INCREMENT AND DECREMENT FUNCTIONS

(71) Applicant: Signature IP Corporation, Milpitas, CA (US)

(72) Inventors: Ralfael Himor, Manila City (PH); Michael Loe Fernandez, Quezon City (PH); Kishore Mishra, Santa Clara, CA (US)

(73) Assignee: Signature IP Corporation, Milpitas, CA (US)

(21) Appl. No.: 19/026,770

(22) Filed: Jan. 17, 2025

Related U.S. Application Data
(60) Provisional application No. 63/688,925, filed on Aug. 30, 2024.
(60) Provisional application No. 63/663,205, filed on Jun. 24, 2024.
(60) Provisional application No. 63/643,941, filed on May 8, 2024.
(60) Provisional application No. 63/551,091, filed on Feb. 8, 2024.

(51) Int. Cl. G06F 9/52; G06F 9/50; G06F 13/36

(52) U.S. Cl. CPC G06F 9/52; G06F 9/5038; G06F 13/36

(57) ABSTRACT

Techniques for bus sharing are disclosed. A plurality of bus requesters is coupled to a common bus. Access requests are stored in a request vector. A relative request vector (RRV) is generated by circular shifting by a rotate value to the right. The RRV is examined for the first asserted bit beginning at a first bit position proceeding in a first direction. A one-hot encoded relative grant vector is generated based on the first asserted bit. A grant vector (GV) is produced by circular shifting by a rotate value to the left. Access is granted. The rotate value is updated, affecting the priority of next grant. The GV is compared to a grant history vector (GHV). A count grant is adjusted. The count grant indicates a number of times that the bus requester indicated by the GHV was granted successive accesses to the common bus.

### RELATED APPLICATIONS

This application claims the benefit of U.S. provisional patent applications “Weighted Round Robin Bus Arbitration With Control Vectors And Increment And Decrement Functions” Ser. No. 63/551,091, filed Feb. 8, 2024, “Coupling Network-On-Chip Sub-Topologies With Derivative Clocks” Ser. No. 63/643,941, filed May 8, 2024, “Cloud-Native Network-On-Chip Validation With Sub-Topologies” Ser. No. 63/663,205, filed Jun. 24, 2024, and “Cloud-Native Network-On-Chip Validation Including Sub-Topologies” Ser. No. 63/688,925, filed Aug. 30, 2024.

Each of the foregoing applications is hereby incorporated by reference in its entirety.

### FIELD OF ART

This application relates generally to logic design and more particularly to weighted round robin bus arbitration with control vectors and increment and decrement functions.

### BACKGROUND

The need for the sharing of resources has been evident from the beginning of time. There are typically finite quantities of resources where there is only so much to go around. When resources are limited, allocation of those resources can become critical, especially when multiple users are involved. Resource sharing can include the concept of taking turns. Taking turns can mean that only one user has access to the resource at a time. Successful sharing can include predefined rules for access, identification of prioritized users, observation of sharing patterns, and more.

In the human experience, a simple example of resource sharing can be observed in the earliest days of a child's education. A child can be told that he can be the first one to play with a toy. A second child can be denied access to the toy and therefore cannot play with the toy while the first child plays with it. Disputes over fairness can arise during the play time. Sharing can be made easier if it is determined in advance how long one child will have exclusive access to the toy before it is handed to the second child. Sharing can often be troublesome because it involves giving as well as taking. Defined rules can allow disputes to be avoided, or quickly identified and averted. Observation and record keeping can be employed to prevent one child from dominating access to the toy that precludes other children from access. There can be some toys that have more potential than a single child can exploit. A set of large construction blocks can provide an example. Due to the surplus potential in a large set of construction blocks, multiple children can play with the set of building blocks at a given time. One child can use a certain quantity of the blocks which leaves the remainder of the set of blocks available to one or more other children. The children's educator can be the authority who decides which child will be first, which child will be second, and so on. The educator, rather than the children, can be the determining factor in the sharing scenario.

The benefits of sharing can include the successful completion of a job that is done by multiple participants, higher efficiencies, and satisfied contributors. Establishing useful sharing rules can go a long way toward carrying us into the future. Resource sharing can involve occupying a resource with one or more other users. Resource sharing can be important in private life, corporate life, and other settings. Numerous benefits of resource sharing can be realized. Multiple objectives can be achieved at the same time. Sharing has its issues, but the many advantages will likely drive additional sharing of resources in the future.

### SUMMARY

A device cannot successfully access bus resources simultaneously with another device on a common bus. Shared interconnected devices on a bus can be managed to avoid bus congestion, data collision, and other issues. A device that requires access to a bus can be a bus requester. In a computer system, two or more bus requesters can make simultaneous requests for the same bus. Requests for bus access can be arbitrated to methodically manage timely access, access for all devices, and so on. Bus arbitration can manage multiple processors to communicate with each other, with shared memory, with peripherals, and so on. Improvements can be realized when device access to the bus can be assigned a priority based on previous access history. Further improvements can be realized when devices on the bus can be assigned a weighted priority depending on the device, the purpose of the device, the task being performed, and so on.

Techniques for bus sharing are disclosed. A plurality of bus requesters is coupled to a common bus. Access requests are stored in a request vector. A relative request vector (RRV) is generated by circular shifting by a rotate value to the right. The RRV is examined for the first asserted bit beginning at a first bit position proceeding in a first direction. A one-hot encoded relative grant vector is generated based on the first asserted bit. A grant vector (GV) is produced by circular shifting by a rotate value to the left. Access is granted. The rotate value is updated, affecting the priority of next grant. The GV is compared to the grant history vector (GHV). A count grant is adjusted. The count grant indicates a number of times that the bus requester, indicated by the GHV, was granted successive accesses to the common bus.

A processor-implemented method for resource sharing is disclosed comprising: accessing a plurality of bus requesters, wherein the plurality of bus requesters is coupled to a common bus by an arbitration logic; requesting, by at least one bus requester, access to the common bus, wherein the requesting is stored in a request vector (RV); generating a relative request vector (RRV), wherein the generating is based on performing, on the RV, N circular shifts in a right direction, wherein N is based on a rotate value; examining a first asserted bit within the RRV, wherein the examining begins at a first bit position within the RRV, wherein the examining proceeds in a first direction; creating a relative grant vector (RGV), wherein the RGV is based on the first asserted bit within the RRV, wherein the RGV comprises a one-hot encoding; producing a grant vector (GV), wherein the producing includes executing, on the RGV, N circular shifts in a left direction; granting access, by the arbitration logic, of the common bus, to a bus requester indicated by the GV; and updating the rotate value, wherein the updating is based on a maximum grant vector (MGV), wherein the MGV specifies a maximum number of times each bus requester is allowed successive accesses to the common bus. In embodiments the examining is based on an incrementing function. In other embodiments, the examining is based on a decrementing function. Embodiments include saving the GV to a GHV, wherein the GHV indicates a last granted requester within the plurality of bus requesters. In embodiments the requesting, the generating, the examining, the creating, the producing, the granting, the updating, and the saving occur in a single clock cycle. In other embodiments the requesting, the generating, the examining, the creating, the producing, the granting, the updating, and the saving are implemented in combinatorial logic.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for weighted round robin bus arbitration with control vectors and increment and decrement functions.

FIG. 2 is a flow diagram for updating the rotate value.

FIG. 3 is an example of a request vector.

FIG. 4 is a first control flow diagram for granting a requester with a weighted incrementing function.

FIG. 5 is a second control flow diagram for granting a requester with a weighted incrementing function.

FIG. 6 is a third control flow diagram for granting a requester with a weighted incrementing function.

FIG. 7 is a fourth control flow diagram for granting a requester with a weighted incrementing function.

FIG. 8 is a control flow diagram to update a grant history vector.

FIG. 9 is a first control flow diagram for granting a requester with a weighted decrementing function.

FIG. 10 is a second control flow diagram for granting a requester with a weighted decrementing function.

FIG. 11 is a third control flow diagram for granting a requester with a weighted decrementing function.

FIG. 12 is a fourth control flow diagram for granting a requester with a weighted decrementing function.

FIG. 13 is a system diagram for weighted round robin bus arbitration with control vectors and increment and decrement functions.

### DETAILED DESCRIPTION

Components in a computing system can be interconnected with other components through a bus. A bus can be a communication path through which information is transferred between two or more components of a computer. Computing information can include data, addresses, commands, controls, and so on. Bus structures have become ubiquitous in computers, control systems, and so on. Bus structures can include common buses that are shared by two or more devices requiring access to interconnected resources. Such devices and resources can include one or more levels of memory, additional central processing unit (CPU) cores, peripheral devices, input/output (IO) devices, and so on. Memory can include cache and local static and dynamic semiconductor memory, graphics processing unit (GPU) memory, spinning and solid state secondary memory, and other types. Physical bus structures can include on-chip interconnects, copper, fiber optic, and other means. Historical bus structures have included parallel buses where a plurality of signals is carried simultaneously and synchronously between a source and destination. Increases in bus speed can favor designs that reduce the number of parallel paths, allow operation at very high speeds, reduce the complexities of synchronization, and so on. Improvements in bus capacity can be realized when high-speed, differential pair, serial transmission schemes replace lower-speed parallel bus topologies. Bus transactions can include packetized traffic. High-speed industry standard bus protocols and physical implementations can include PCI Express (Peripheral Component Interconnect Express or PCI-E), Compute Express Link (CXL), Ethernet, Universal Serial Bus (USB), and so on.

A computing system bus can be a communication path through which information is transferred between two or more components of a computer system. Computing information can include data, addresses, commands, controls, and so on. Buses have become almost universal in computers, control systems, and so on. Buses can include hardware related elements such as wires, fiber, and other conductors. At other computing levels, buses can include software communication protocols such as rules, communications synchronization, error detection, error correction, error recovery, and so on. Bus implementations in a computer system can include common buses. Common buses can be shared by two or more devices that need access to interconnected resources. Resources typically instituted in computer systems can include one or more memories, one or more processor cores, one or more peripheral devices such as input/output devices, and so on.

Memories can include one or more levels of cache memory such as random access memory (RAM), dynamic random access memory (DRAM), and so on. Memories can include primary memories implemented with RAM, DRAM, and so on. Memories can also include secondary memories which can be implemented as non-volatile solid state memory devices, non-volatile spinning memory devices, and so on. Memories can be volatile in which data is lost when power is removed, or non-volatile in which data is retained when power is removed. Memories can be connected to a bus physically, electrically, logically, and so on. Memory devices on a common bus must have cooperative relationships for successful operation.

Processor cores can execute instructions of a software program. Instructions can include logic processes, arithmetic computations, control processes, and IO operations. For example, a processor design can include an arithmetic logic unit (ALU) that processes arithmetic and logical operations, and a set of registers that can contain input operands for the ALU and output results from the ALU. A processor design can further include control circuitry that coordinates the fetching and decoding of instructions from memory, the fetching of data from memory, the processing of instructions and data, and so on. Modern processor cores can be implemented in semiconductor chip platforms and can contain a plurality of internal common buses, external common buses, and so on. A common bus can be located within a processor core, between cores on a multi-core processor, between cores/multi-processor cores on a system-on-a-chip (SoC), between SoCs, and so on. Processor cores can be connected to a bus physically, electrically, logically, and so on. Connected processor cores on a common bus must have cooperative relationships for successful operation.

Peripheral devices can include additional storage devices such as removable transient storage devices, graphics processing units (GPUs), external bus interface devices, memory expansion units, external memory interfaces, bus diagnostics units, bus protocol translation units, wireless communications interfaces, human interface devices (HIDs), and so on. HIDs can include keyboards, displays, and so on. Peripheral devices can be connected to a bus physically, electrically, logically, and so on. Connected peripheral devices on a common bus must have cooperative relationships for successful operation. High-speed, serial, industry standard bus protocols and physical implementations can include PCI Express (Peripheral Component Interconnect Express or PCI-E), Compute Express Link (CXL), Ethernet, Universal Serial Bus (USB), and so on. Historically, bus structures have included parallel groups of electrical wires where a plurality of signals is carried simultaneously and synchronously between source hardware and destination hardware. Increases in bus speed have favored designs that reduce the number of parallel paths, allow operation at very high speeds, reduce the complexities of synchronization, and implement other improvements. In addition to the physical bus implementations, bus design can include logical implementations that allow the interconnection of two or more devices. Improvements in bus capacity can be realized when high-speed, differential pair, serial transmission schemes replace lower-speed parallel bus topologies. High speed bus transactions can often include packetized traffic which can avoid the inefficiencies that result from pre-allocated bus bandwidth. Packetized communications can allow a bus to be occupied, used, and efficiently released for other related or unrelated traffic. PCI-E, CXL, Ethernet, USB, and other buses are examples of industry protocols that employ packetized communications.

PCI Express (Peripheral Component Interconnect Express), or PCI-E, is a common interface that is used for communication between electrical components, motherboards and daughtercards, and so on. A PCI-E bus can include one or more lanes, where each lane is comprised of a send and receive line. Data traffic in a lane can operate at high speeds, sometimes in the gigabit-per-second range for PCI-E bus devices. PCI-E logic can be included in a chipset form or, with trends in die-shrink and transistor density, can be incorporated directly within the CPU to reduce signal latency and increase speed. Another bus standard that is similar to PCI-E is the Compute Express Link (CXL). CXL was designed for high-speed interconnection between CPU and endpoint devices, CPU-to-memory interconnects, and so on. The Universal Serial Bus (USB) is also a serial bus standard. At the electrical level, a USB can include a single differential pair of conductors or two or more pairs of conductors that operate at significantly higher transmission speeds. The Ethernet networking technology is commonly found in local area networks (LANs), wide area networks (WANs), and other communications topologies.

A device cannot successfully occupy and consume bus resources simultaneously with another device on a common bus. Shared interconnected devices on a bus can be managed to avoid bus congestion, data collision, and other issues. A device that requires access to a bus can be a bus requester. In a typical computer system, there can be simultaneous requests for bus access from two or more bus requesters. Requests for bus access can be arbitrated to methodically manage timely access; to allow access for all devices; to allow multiple processors to communicate with each other, with shared memory, and with peripherals; and so on. A typical methodology for bus arbitration can employ the concept of a round robin methodology. A round robin methodology can be used to choose the ordering of the elements in a group of elements, where each element is given a chance, in turn, to participate. Round robin often includes the return back to the beginning of the group of elements for repeated additional selection and participation. Another methodology that can be employed in bus arbitration is the concept of weighting. The process of weighting can allow a greater number of access cycles for one bus device over others. Access weighting can be adjusted depending on the bus device and its tasks.

For certain operations, the contents of a data word can be limited to a single instance of a one in a field of zeros. Such encoding is referred to as one-hot encoding. A one-hot encoding can be useful because the state of the word can be immediately known without the need for a binary decode operations. A one-hot encoding can be useful for fast processing of logical and other functions. A one-hot encoding can also be useful for logic that is implemented in combinatorial logic. Combinatorial logic can be implemented as a collection of Boolean circuits where the output is based on the present inputs and is not based on past state history. Combinatorial logic can often perform in a single clock cycle and can therefore be fast compared to a state machine that factors past history into the processing.

Fast performance can be a significant factor in managing traffic on a bus as described earlier. In typical computer systems, a round robin arbitration scheme can be implemented to ensure that multiple bus requestors obtain access to the bus. However, performance problems can occur when one bus gains or maintains priority of the bus over other requesters. For example, in a typical arbitration scheme, requester A can be granted access to a common bus when it has a request. If requester A does not have a request, requester B can be granted access to the bus when requester B has a request. A problem with this scheme is that requester A is always granted access to the bus when it has a request. This can lead to code blocking, task starvation, and bottlenecks in other parts of the system. A common solution to this problem has been to implement multiple nested if/then loops in software so that the arbitration scheme always proceeds to the next requester in the following round of arbitration. However, these schemes can be costly to implement in combinatorial logic, state machines, and so on. Disclosed embodiments provide a unique, easy to implement round robin arbitration scheme with incrementing and decrementing priority, eliminating bottlenecks caused by other simple arbitration schemes. Disclosed embodiments provide a system wherein fair access to a bus is provided for one or more requesters that prevents a single requester from dominating bus access. Because of simplicity of implementation, additional embodiments allow access grants to be decided in one cycle, which can be a significant performance improvement over typical bus arbitration schemes.

In disclosed embodiments, a plurality of bus requesters can be accessed. The plurality of bus requesters can be coupled to a common bus by an arbitration logic. At least one bus requester in the plurality of bus requesters can request access to the common bus. The request from the bus requester can be stored in a request vector (RV). A relative request vector (RRV) can be generated. The generating can be based on performing, on the RV, N circular shifts in a right direction. N can be based on a rotate value. A first asserted bit within the RRV can be examined. The examining can begin at a first bit position within the RRV. The examining can proceed in a first direction. A relative grant vector (RGV) can be created. The RGV can be based on the first asserted bit within the RRV. The RGV can comprise a one-hot encoding. A grant vector (GV) can be produced. The producing can include executing, on the RGV, N circular shifts in a left direction. The arbitration logic can then grant access to the common bus for the bus requester indicated by the GV. The rotate value can be updated. The updating can be based on a maximum grant vector (MGV). The MGV can specify a maximum number of times each bus requester is allowed successive accesses to the common bus. Embodiments include the examining, which can be based on an incrementing or decrementing function. Embodiments include initializing a rotate value (RV), a count grant (CG), a grant history vector (GHV), and a maximum grant vector (MGV) upon reset. Embodiments include comparing the GV to the GHV. Embodiments include adjusting a count grant (CG) depending on the comparison of GV and GHV. Other embodiments include saving the GV to the GHV. Embodiments include the execution of the aforementioned process in combinatorial logic in the arbitration logic, and in a single clock cycle.

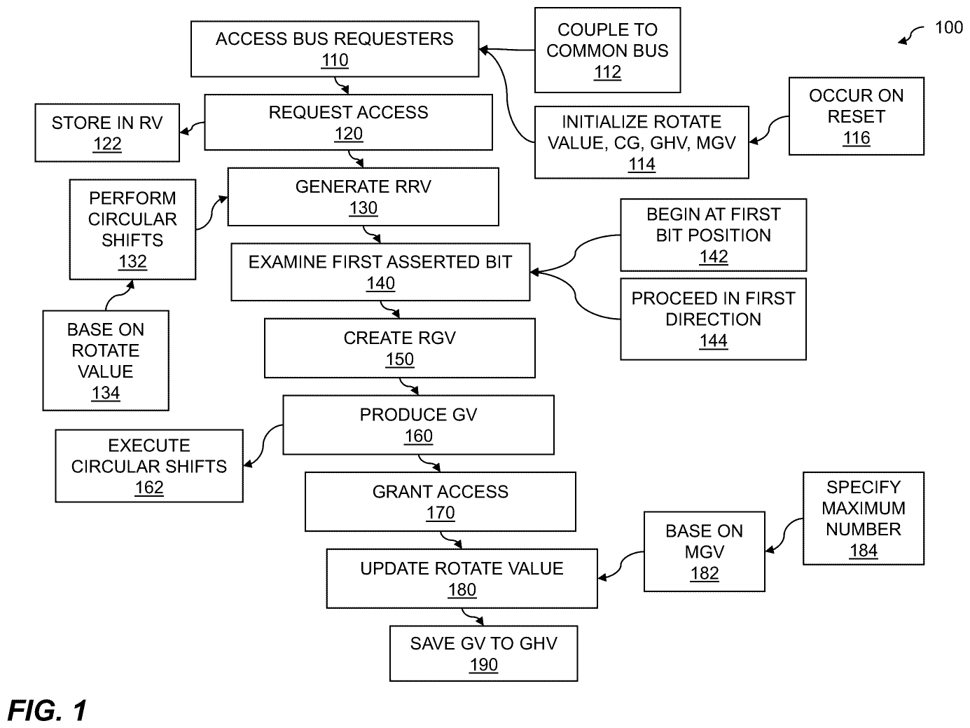

FIG. 1 is a flow diagram for weighted round robin bus arbitration with control vectors and increment and decrement functions. Disclosures include a processing methodology that allows a system to assign bus access to a requester within a plurality of requesters in a way that prevents a single requester from dominating bus access, at the same time providing greater successive access cycles for preselected requesters. Additional embodiments allow access grants to be decided in one cycle. Requests are made by devices on the bus that wants access to the bus. Access can include memory access, CPU core access, and so on. The disclosed techniques can process the requests by factoring in past request history, and can grant access to the next requestor.

The flow 100 includes accessing a plurality of bus requesters 110, wherein the plurality of bus requesters is coupled to a common bus 112 by an arbitration logic. Bus requesters can include devices that are coupled to a common bus. Connected bus requesters can include one or more devices that need to access one or more memories, one or more processors, one or more input/output devices, and so on. Common buses can include buses that are internal or external to a computer system. Common buses can further include parallel buses that carry data words in parallel. Common buses can also include serial buses that carry data one bit at a time, sequentially, over a communications path. In embodiments, a common bus comprises a PCI-E bus. In embodiments a common PCI-E bus can include a plurality of PCI-E bus controllers. In further embodiments, the common bus comprises a compute express link (CXL) bus. In other embodiments the common bus comprises an Ethernet bus. In additional embodiments, the common bus comprises a universal serial bus (USB). A common bus can comprise other high speed bus structures and protocols. Arbitration logic in disclosed embodiments can coordinate accesses to the common bus by the various bus requesters. Arbitration logic can be implemented in software, hardware, or a combination of the two. Arbitration logic can be implemented as a single centralized logic structure that performs bus arbitration across the entire set of connected bus requesters. Arbitration logic can also be implemented as a distributed system of logic that includes the connected bus requesters in the arbitration process. Embodiments include a rotate value, a grant history vector (GHV), and a maximum grant vector (MGV). Additional embodiments include initializing the rotate value, the CG, the GHV, and the MGV 114. In other embodiments, the initializing occurs on a reset 116. In further embodiments, the rotate value, the CG, and the MGV comprise a decimal format.

The flow 100 includes requesting 120, by at least one bus requester, access to the common bus, wherein the requesting is stored in a request vector (RV) 122. A bus requester can request access to the common bus. The requesting access 120 can be required by the requesting device to send or receive communications on the bus. One or more requesters can request access to the common bus at the same time. A bus request can be retained for use in bus arbitration. A bus request can be stored in a request vector (RV). An RV can comprise one or more bits and can be implemented in software, hardware, or both. An RV can be on-chip register space, on-chip memory space, external memory space, and so on. An RV can have each bit of its one or more bit positions assigned to a requesting device. As an example, a common bus can be coupled to four processor cores and a memory element. In this case, the RV can include four bits. The first bit can be the rightmost bit of the four bits and can be a least significant bit (LSB). The LSB can be assigned to a first processor. The next bit to the left, the second bit, can be assigned to a second processor. The third and fourth bits can be assigned other processor cores. In this example, the first processor can execute instructions that can require an access to the memory element on the common bus. As a result, the first bit in the RV can contain a “1”. If the second CPU also requires access to the memory through the common bus, the second bit in the RV can also contain a “1”. The RV can be an input signal that can be used by disclosed embodiments to coordinate and grant access to requesting devices for access to the common bus.

The flow 100 includes generating 130 a relative request vector (RRV), wherein the generating is based on performing, on the RV, N circular shifts 132 in a right direction, wherein N is based on a rotate value 134. Recall that the rotate value can be initialized upon reset 116. A circular shift can be associated with a data word that contains two or more bit positions. The data word can contain a bit position defined as the least significant bit (LSB) and a position that can be defined as a most significant bit (MSB). The LSB and MSB can be at the limits of the data word itself or can be assigned bit positions somewhere within the word. The LSB and the MSB can be the bounding limits for the circular shift. Consider the example of an eight-bit register where bit 0 is the right-most bit and can be assigned as the LSB, and bit 7 is the left-most bit and can be assigned as the MSB. A circular shift can occur in an incrementing or decrementing fashion. For this example, an incrementing circular shift occurs when the original contents of bit 0 is moved to bit 1, the original contents of bit 1 are moved to bit 2, and so on through the remainder of the register bits. The original contents of bit 7, the MSB, are moved to bit 0, the LSB. An incrementing circular shift can be a circular shift to the left. In another example, a decrementing circular shift occurs when the original contents of bit 1 are moved to bit 0, the original contents of bit 2 are moved to bit 1, and so on through the remainder of the register bits. The original contents of bit 0, the LSB, are moved to bit 7, the MSB. A decrementing circular shift can be a circular shift to the right. Moving bits in a register or data word bounded by MSB and LSB can be done for arithmetic, logical, and other operations. In disclosed embodiments, the number of circular shifts performed on the RV can be based on circular shifting, to the right, one or more times depending on the rotate value 134. When the circular shifts have completed as described above, the RV can then be copied to the RRV.

The flow 100 includes examining 140 a first asserted bit within the RRV, wherein the examining begins at a first bit position 142 within the RRV, wherein the examining proceeds in a first direction 144. The disclosed technique can be accomplished by an incrementing function or a decrementing function. In the case of an incrementing function, the examining for a first asserted bit in the RRV can begin at the LSB of the RRV. The examining can proceed to the left, bit by bit, until an asserted bit (a “1”) is encountered. In the case of a decrementing function, the examining for a first asserted bit in the RRV can begin at the MSB of the RRV. The examining can proceed to the right, bit by bit, until an asserted bit (a “1”) is encountered.

The flow 100 includes creating a relative grant vector (RGV) 150, wherein the RGV is based on the first asserted bit within the RRV, wherein the RGV comprises a one-hot encoding. Recall that the examining 140 revealed a first asserted bit that identified a bus requester that had requested access. Additional bit positions can be asserted (a “1”) in the RGV if there are additional bus requesters requesting access to the common bus. This first asserted bit can be the requester of interest. The disclosed technique includes creating a one-hot encoding based on the first asserted bit encountered. A one hot encoding can be useful because the state of the word can be immediately known without the need for a binary decode operation.

The flow 100 includes producing a grant vector (GV) 160, wherein the producing includes executing, on the RGV, N circular shifts 162 in a left direction. Recall that N circular shifts in a right direction had been previously performed, wherein N was based on a rotate value. The RGV is now rotated the same number, N, of circular shifts in the opposite direction, left, to move the first asserted bus requester into the bus requesters assigned position in the GV.

The flow 100 includes granting access 170, by the arbitration logic, of the common bus, to a bus requester indicated by the GV. Recall that the RGV was one-hot encoded. The GV can also be one-hot encoded. After N circular shifts 162, the GV can be one-hot encoded and can be ready for use by the arbitration logic to grant access to the bus requester. The resulting grant vector can indicate the requester that will be granted access to the common bus. Once granted access to the common bus, the requester can initiate its operation on shared resources.

The flow 100 includes updating the rotate value 180, wherein the updating is based on a maximum grant vector (MGV) 182, wherein the MGV specifies a maximum number of times 184 each bus requester is allowed successive accesses to the common bus. Recall that the MGV was initialized upon reset. The disclosed technique can be accomplished by an incrementing function or a decrementing function. In both cases, if the number of successive access grants to a bus device is less than the maximum predefined number allowed for that bus device, the rotate value can be adjusted so that the same bus device can be the next to receive access to the common bus. If the number of successive access grants to a bus device is not less than the maximum predefined number allowed for that bus device, the rotate value can be adjusted so that the next bus device can be the next to receive access to the common bus. In the case of an incrementing function, the next bus device can be the next bus to the left in the RV. In the case of a decrementing function, the next bus device can be the next bus to the right in the RV.

The flow 100 can further comprise saving the GV to a GHV 190, wherein the GHV indicates a last granted requester within the plurality of bus requesters. In embodiments the last granted requester comprises a bus requester in the plurality of bus requesters which was granted a most recent access to the common bus. In embodiments, the GHV comprises a number of bits, wherein the number of bits is equal to a number of bus requesters in the plurality of bus requesters. Because the GV is one-hot encoded, the new GHV can also be one-hot encoded and can thus prepare the logic for the next bus request. Recall that bus requests can come from one or more devices connected to a common bus. The common bus can comprise a PCI-E bus, CXL bus, Ethernet, USB, and so on. A single such connected device can obtain access to the common bus due to the granting.

Various steps in the flow 100 may be changed in order, repeated, omitted, or the like without departing from the disclosed concepts. Various embodiments of the flow 100, or portions thereof, can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

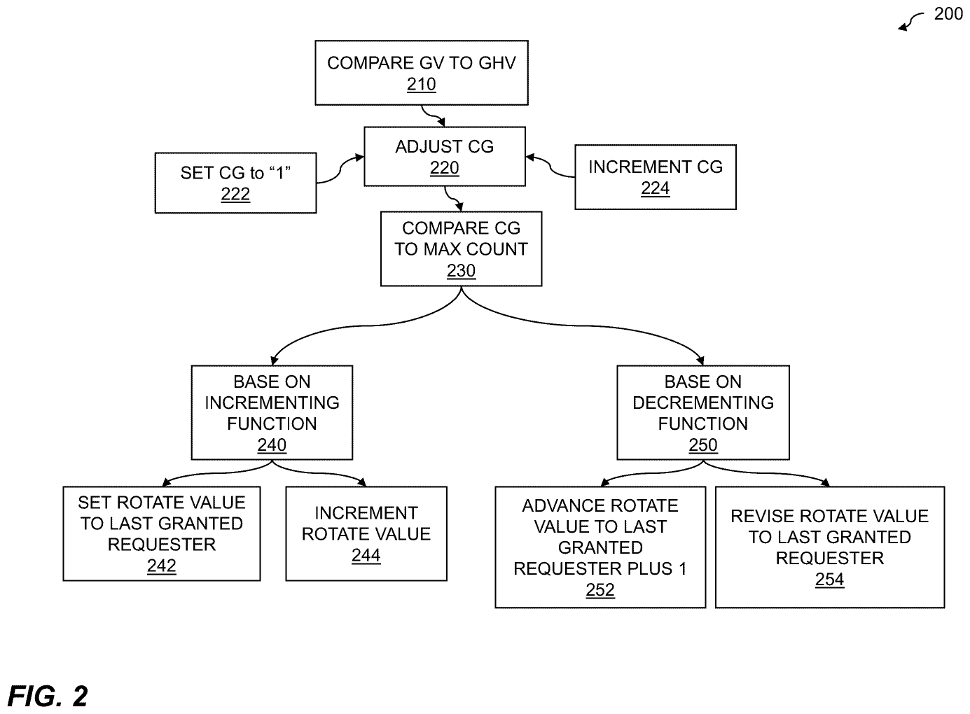

FIG. 2 is a flow diagram for updating the rotate value. Disclosures include a processing methodology that allows a system to assign bus access to a requester within a plurality of requesters in a way that prevents a single requester from dominating bus access, at the same time providing greater successive access cycles for preselected requesters. The disclosed techniques can process the requests by factoring in past request history and the number of successive request grants, and grant access to the next requestor. Embodiments can include initializing the rotate value, the CG, the GHV, and the MGV. Embodiments include adjusting a count grant (CG) depending on the comparison of GV and GHV. Embodiments include the examining, which can be based on an incrementing or decrementing function.

The flow 200 includes comparing the GV to the grant history vector (GHV) 210. Recall that because the GV was one-hot encoded, the new GHV can also be one-hot encoded and can thus prepare the logic for the next bus request. The GV can contain the identity of the current device that is requesting access to the common bus. The GHV can contain the identity of the previous device that requested access to the common bus. Accurate updating of the rotate value can depend on the result of the comparison of the GV to the GHV.

The flow 200 includes adjusting a count grant (CG) 220, wherein the count grant indicates a number of times that the bus requester indicated by the GHV was granted successive accesses to the common bus. The adjusting can include one of two operations depending on the results of the comparison of the GV and the GHV. If the device was granted access to the common bus a second or additional times in succession, the adjusting can adjust the number of successive accesses by one. If the device was granted access for the first time after a different device was granted access to the common bus, the adjusting can reset the number of successive accesses to “1”.

The flow 200 includes setting the CG to “1” 222, wherein the GV does not match the GHV. This can be due to the bus device requesting access to the common bus for the first time after a different bus device had been granted access to the common bus. Because in this case the new bus requester would be granted access to the common bus for the first time, the adjusting can reset the number of successive accesses to “1”. The flow 200 includes incrementing the CG, wherein the GV matches the GHV 224. This can be due to the bus device requesting access to the common bus after it had just been granted bus access. Successive bus accesses can be comprised of a series of bus accesses to the common bus by a given bus device with no intervening bus devices being granted access. In this case, the adjusting can adjust the number of successive accesses by one. If the CG was “1”, the adjusting can result in the CG being set to “2”. If the CG was “2”, the adjusting can result in the CG being set to “3”, and so on.

The flow 200 includes comparing the CG to a maximum count 230, wherein the maximum count comprises a value in the MGV associated with the bus requester indicated by the GV. The number of successive accesses to the common bus can be a factor in the bus grant activity. The disclosed embodiments include factoring a maximum number of successive bus accesses into the decision to grant access to the current bus requesting device or to deny the request and move to the next bus requesting device. This operation can depend on whether an incrementing or decrementing function is used.

The flow 200 includes comparing based on an incrementing function 240. The logical flow of the disclosed techniques can employ an incrementing function or a decrementing function in the final determination of bus access. An incrementing function 240 can be used depending on the requirements of the hardware logic structure, or the software logic structure, or a combination of the two. Logic optimization can have a significant effect on the operation speed of hardware logic, software logic, or a combination of the two. Logic efficiency can have a significant effect on the electronic circuitry space requirements in hardware logic, or on the memory space requirements for software logic, or a combination of the two.

The flow 200 includes setting the rotate value to the last granted requester 242, wherein the CG is less than the maximum count. In the incrementing function 240, the rotate value can be used to determine which bus requester of the plurality of bus requesters to the common bus will be given first access on the next request-grant cycle. The CG of the current bus requesting device can reveal the number of successive grants to the common bus the current bus requesting device has received. If the number of successive grants by the current requesting device to the common bus is less than the maximum count that is associated with the current requesting device, the rotate value can be set to the last granted bus requester, which can be the current bus requester. The current bus requester can then have access to the common bus in the next request-grant cycle by the current bus requester.

The flow 200 includes incrementing the rotate value 244, wherein the CG is not less than the maximum count. In the incrementing function 240, the rotate value can be used to determine which bus requester of the plurality of bus requesters to the common bus will be given first access on the next request-grant cycle. The CG of the current bus requesting device can reveal the number of successive grants to the common bus the current bus requesting device has received. If the number of successive grants by the current requesting device to the common bus is equal to or greater than the maximum count that is associated with the current requesting device, the rotate value can be incremented. This can prevent the current bus requester from obtaining bus access in the next request-grant cycle, and allows the next bus requester to have access to the common bus.

The flow 200 includes comparing based on a decrementing function 250. The logical flow of the disclosed techniques can employ an incrementing function or a decrementing function in the final determination of bus access. A decrementing function 250 can be used depending on the requirements of the hardware logic structure, or the software logic structure, or a combination of the two. Logic optimization can have a significant effect on the operation speed of hardware logic, software logic, or a combination of the two. Logic efficiency can have a significant effect on the electronic circuitry space requirements in hardware logic, or on the memory space requirements for software logic, or a combination of the two.

The flow 200 includes advancing the rotate value to the last granted requester plus 1, wherein the CG is less than the maximum count 252. In the decrementing function 250, the rotate value can be used to determine which bus requester of the plurality of bus requesters to the common bus will be given first access on the next request-grant cycle. The CG of the current bus requesting device can reveal the number of successive grants to the common bus the current bus requesting device has received. If the number of successive grants by the current requesting device to the common bus is less than the maximum count that is associated with the current requesting device, the rotate value can be set to the last granted requester plus “1”. The current bus requester can then have access to the common bus in the next request-grant cycle.

The flow 200 includes revising the rotate value to the last granted requester 254, wherein the CG is not less than the maximum count. In the decrementing function 250, the rotate value can be used to determine which bus requester of the plurality of bus requesters to the common bus will be given first access on the next request-grant cycle. The CG of the current bus requesting device can reveal the number of successive grants that the current bus requesting device has received. If the number of successive grants by the current requesting device to the common bus is equal to or greater than the maximum count that is associated with the current requesting device, the rotate value can be revised to the last granted requester 254, which can be the current bus requester. This can prevent the current bus requester from obtaining access to the common bus in the next request-grant cycle, and can allow the next bus requester to have access to the common bus instead.

Various steps in the flow 200 may be changed in order, repeated, omitted, or the like without departing from the disclosed concepts. Various embodiments of the flow 200, or portions thereof, can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

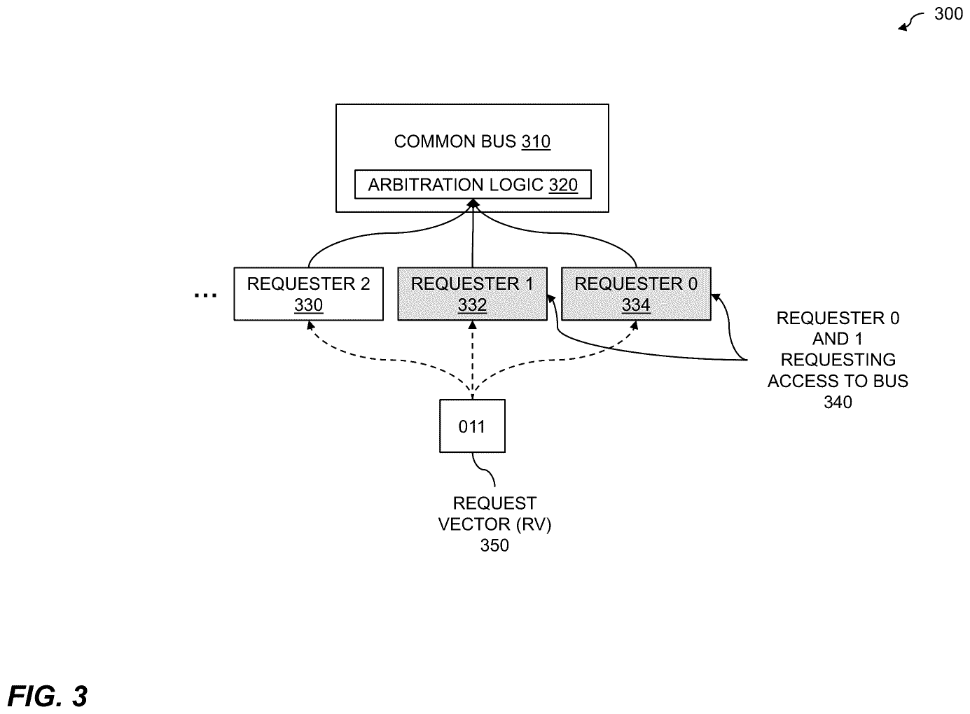

FIG. 3 is an example of a request vector. Embodiments include accessing a plurality of bus requesters, wherein the plurality of bus requesters is coupled to a common bus by an arbitration logic. The example 300 includes one or more devices that can be coupled to a common bus 310. The one or more devices can request access to the common bus when they need to perform bus transactions. Examples of bus transactions include a processor core writing to a memory on the common bus, another processor core communicating with an external device on the common bus, and so on. The previously described common bus can be electrically and/or logically configured as PCI-E, CXL, Ethernet, USB, and other bus types. When coupled to a common bus, access requests can be managed to allow one bus requester access at a time. The example 300 includes arbitration logic 320 that can comprise hardware circuitry, software logic instructions, or a mix of the two. Arbitration logic can grant orderly bus access based on a bus access protocol. In embodiments, bus access is granted in a round robin technique that avoids domination of the bus by a single requester.

Embodiments include requesting, by at least one bus requester, access to the common bus, wherein the requesting is stored in a request vector (RV). The example 300 includes three bus requesters. Requester 0 can be one of the bus requesters. Requester 0 334 can be one of a plurality of processor cores, a memory, and so on. Requester 1 332 can be one of a plurality of processor cores, a memory, and so on. Requester 2 330 can be one of a plurality of processor cores, a memory, and so on. All or some of the three requesters can be the same or different. In practice, there can be more or fewer bus requesters. In this example, requester 0 and requester 1 are requesting access to the common bus 340, and requester 2 is not requesting access to the common bus. Requester 0 and requester 1 may have issued simultaneous requests for access to the common bus, or may have issued requests for bus access displaced in time. The example 300 illustrates the present state of the three requesters 330, 332, and 334. The requester states can be stored in a RV 350. Each requester can be assigned a single bit position. A requester can be identified by the bit position it occupies. The example 300 employs positive logic where a “1” in a bit position will show an active bus request. Request vector 350, therefore, contains “011” to indicate that requester 0 334 and requester 1 332 are requesting access to the common bus, and that requester 2 330 is not requesting access to the common bus. An RV can have zero or more bits active at any one time. The example 300 includes the illustration of three requesters in the RV, but in practice, the RV can be any length of one or more bits.

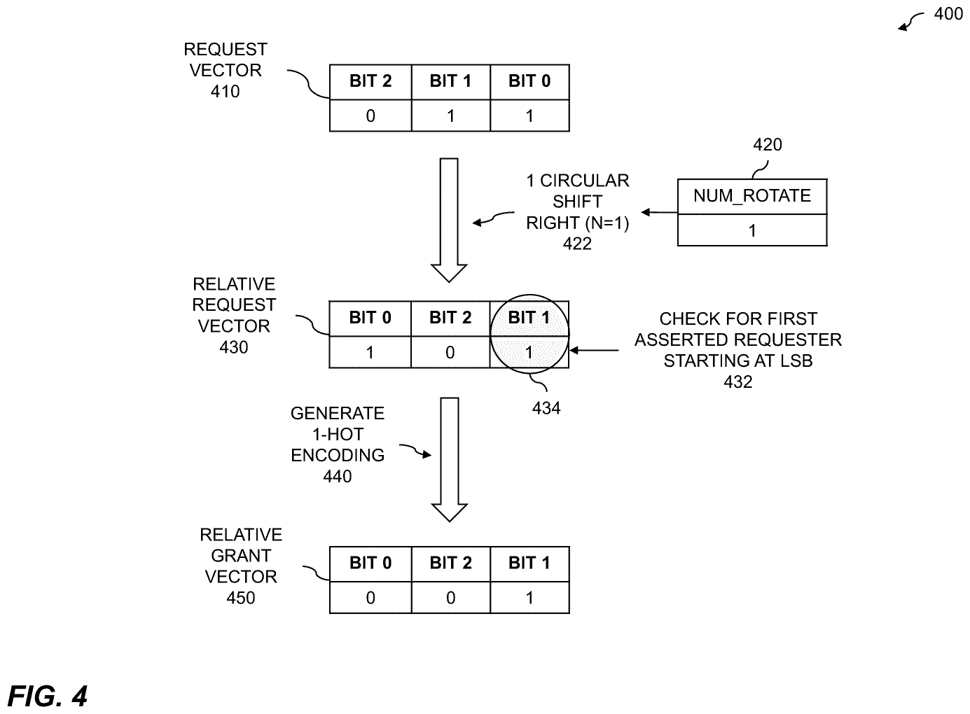

FIG. 4 is a first control flow diagram for granting a requester with a weighted incrementing function. As described above and throughout, one or more requesters can request access to the common bus. There can be simultaneous requests for access by the one or more requesters. A bus request can be retained for use in bus arbitration. Recall that the one or more bus requests can be stored in a request vector (RV). An RV can comprise one or more bits and can be implemented in software, hardware, or both. An RV can be located in on-chip register space, on-chip memory space, external memory space, and so on. An RV can have each bit of its one or more bit positions assigned to a requesting device. As an example, a common bus can be coupled to three processor cores and a memory element. In this case, the RV can include three bits. The first bit can be the rightmost bit of the three bits and can be a least significant bit (LSB). The LSB can be assigned to a first processor. The next bit to the left, the second bit, can be assigned to a second processor. The third bits can be assigned other processor cores. In practice, the RV can include any number of bits representing any number of bus requesters. In this example, the first processor can execute instructions that can require access to the memory element on the common bus. As a result, the first bit in the RV can contain a “1”. If the second CPU also requires access to the memory through the common bus, the second bit in the RV can also contain a “1”. The RV can be an input signal that can be used by disclosed embodiments to coordinate and grant access to requesting devices to the common bus.

The control flow 400 includes requesting, by at least one bus requester, access to the common bus, wherein the requesting is stored in a request vector (RV) 410. In the control flow 400 example, the RV is three bits in length where the leftmost bit, bit 2, can be the most significant bit (MSB), and the rightmost bit, bit 0, can be the least significant bit (LSB). In the example, bit 0 contains a “1” which can mean that bus device 0 has requested access to the common bus. Bus device 0 can be a first processor core or another requesting device. Also in this example, bit 1 contains a “1” which can mean that bus device 1 has requested access to the common bus. Bus device 1 can be a second processor core or another requesting device. And finally in this example, bit 2 contains a “0” which can mean that bus device 2 has not requested access to the common bus. Bus device 2 can be a third processor core or another requesting device.

The control flow 400 includes a rotate value 420. The rotate value can be used with an incrementing function or a decrementing function described previously. The rotate value can be used to determine which bus requester of the plurality of bus requesters to the common bus will be given first access on the next request-grant cycle. The rotate value can be updated at the end of each request-grant cycle and can be based on the MGV which can be further based on a specified maximum number of successive bus accesses. In the control flow 400 example, the rotate value is set to “1” decimal. The MGV can be a decimal, binary, or some other stored value.

The control flow 400 includes generating a relative request vector (RRV), wherein the generating is based on performing, on the RV, N circular shifts 422 in a right direction, wherein N is based on a rotate value. Because the rotate value is set to “1” in the control flow 400 example, N=1, one circular shift 422 is performed on the RV 410. In the example, the circular shift to the right results in moving bit 2, the MSB, and the bit position assigned to bus requester 2, one bit to the right in the RRV 430. The circular shift to the right also results in moving bit 1, the bit position assigned to bus requester 1, one bit to the right in the RRV 430. The circular shift to the right also results in moving bit 0, the LSB, and the bit position assigned to bus requester 0, one bit to the right which rolls it around to the MSB in the RRV 430. The bus request states of each of the three bus requesters move to the new bit positions in the RRV. Thus, the RRV 430 can now be one bit circular shifted relative to the RV 410.

The control flow 400 includes examining 432 a first asserted bit within the RRV, wherein the examining begins at a first bit position within the RRV, wherein the examining proceeds in a first direction. In embodiments, the examining can be based on an incrementing function. In additional embodiments, the first bit position is a least significant bit position. In further embodiments, the first direction is to the left. Thus, the search for a first asserted bit, a “1”, in the RRV can begin at the least significant bit and can proceed in a left direction. In the control flow 400 example, the examining 432 found an asserted bit 434, a “1”, at the least significant bit position of the RRV 430.

The control flow 400 includes creating a relative grant vector (RGV), wherein the RGV is based on the first asserted bit within the RRV, wherein the RGV comprises a one-hot encoding 440. In the control flow 400 example, the RRV contains “101” where the rightmost “1” is the first asserted bit 434. The one-hot encoding of the RRV can be “001” and can become the RGV 450. In the example, the RGV contains a “1” at the bit position of the first asserted bit found by examination 432. The bit position “1” is associated with bus requester 1 among bus requesters 0, 1, and 2. In the example, bus requester 1 was associated with the first asserted bit and is therefore identified as the bus requester to be granted access to the common bus. As with the RRV 430, the RGV 450 bit associations can be relative, based on the circular shifting 422 previously done to the RRV.

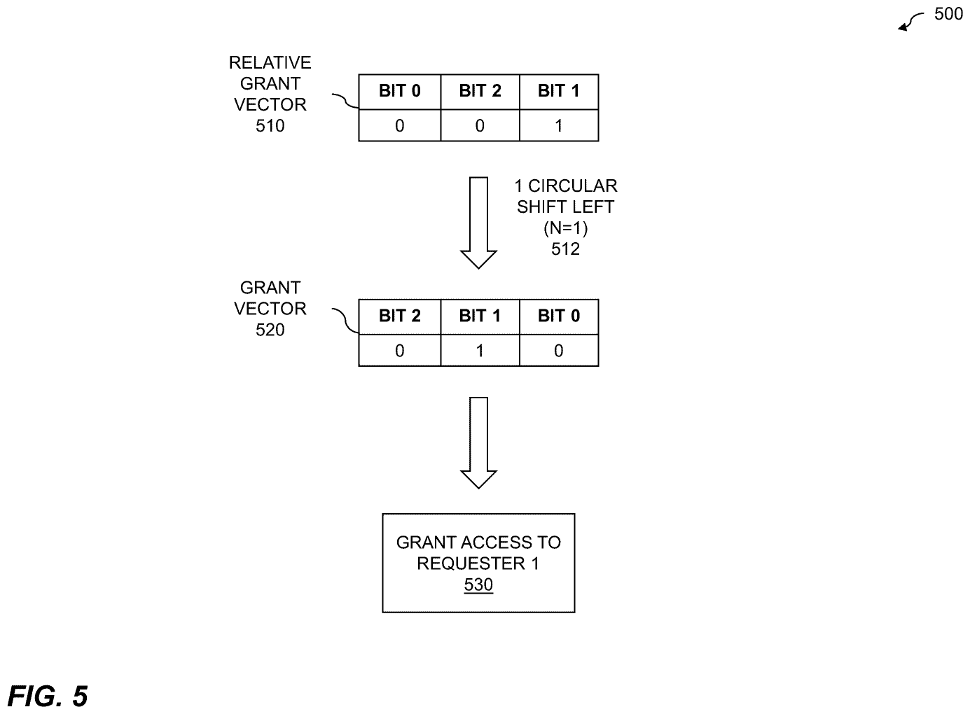

FIG. 5 is a second control flow diagram for granting a requester with a weighted incrementing function. The control flow 500 example is a continuation of the control flow 400 example. In embodiments, the RGV 510 is one-hot encoded. In the control flow 500 example the RGV contains “001”. The single bit position that is set to “1” is associated with bus requester 1 among bus requesters 0, 1, and 2. The RGV 510 bit associations can be relative due to the one or more previous circular shifts 422. Because of the relative placement in the RGV, bus requester 1 is not yet in its proper position to be useful as a grant vector. Circular bit shifting can be employed to move it to its proper position in the GV. The bit shifting can essentially undo the circular shifting previously done to the RV in 410.

The control flow 500 includes producing a grant vector (GV), wherein the producing includes executing, on the RGV 510, N circular shifts 512 in a left direction. Recall in the control flow 400 example, the rotate value was set to “1” decimal, so N=1. In the control flow 500 example, one circular shift 512 to the left is performed on the RGV. In the example, the circular shift to the left results in moving bit 1, the LSB of the RGV and the bit position presently associated with bus requester 1, one bit to the left in the GV 520. This places the state of bus requester 1 at physical bit 1 of the GV. The circular shift to the left also results in moving bit 2 of the RGV, the bit position associated with bus requester 2, one bit to the left in the GV 520. This places the state of bus requester 2 at physical bit 2 of the GV. The circular shift to the left also results in moving bit 0, the MSB, and the bit position assigned to bus requester 0, one bit to the left which rolls it around to the LSB in the GV 520. This places the state of bus requester 0 at physical bit 0 of the GV. The resulting GV has bit 0 as the request state of bus device 0, bit 1 as the request state of bus device 1, and bit 2 as the request state of bus device 2. In the example, the GV 520 contains “010”. The single bit position that is “1” is associated with bus requester 1 among bus requesters 0, 1, and 2.

The control flow 500 includes granting access 530, by the arbitration logic, of the common bus, to a bus requester indicated by the GV. In the control flow 500 example, the GV 520 contains “010”. The bit position that is “1” is associated with bus requester 1 among bus requesters 0, 1, and 2. The arbitration logic therefore can allow bus access to bus requester 1. The GV is one-hot encoded. One-hot encoding can be useful because the state of the word can be immediately known without the need for a binary decode operation. One-hot encoding can be useful for fast processing of logical and other functions.

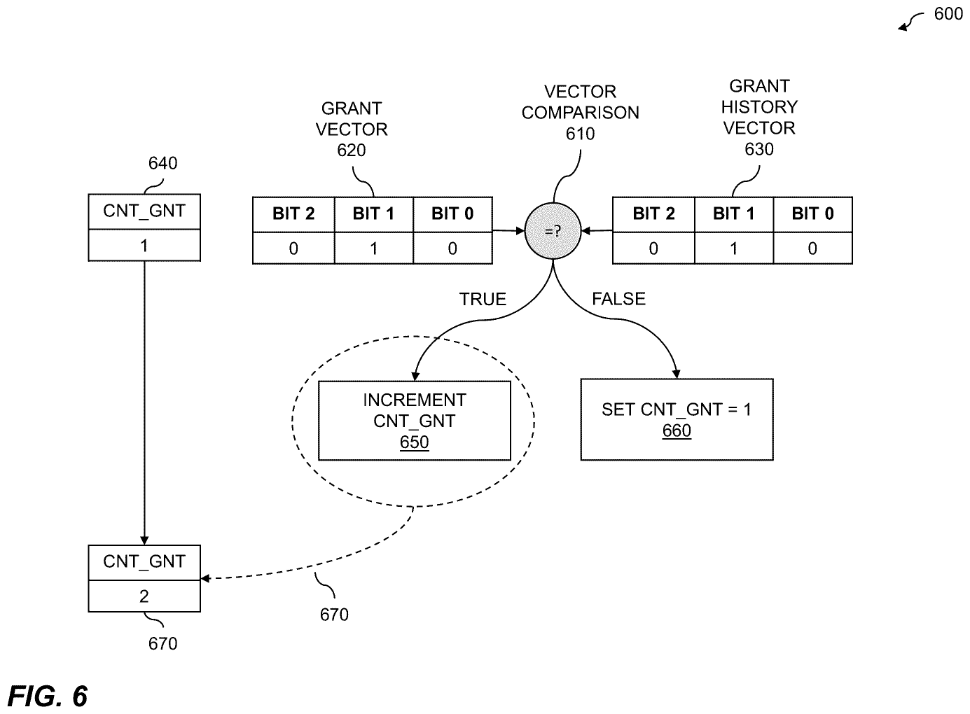

FIG. 6 is a third control flow diagram for granting a requester with a weighted incrementing function. The control flow 400 and the control flow 500 illustrate how the selection of the next bus requester can be accomplished. After the selection is accomplished and bus access is granted, the disclosed technique can determine the number of successive bus accesses that have been granted to a single bus requester of the common bus. The control flow 600 example is a continuation of the control flow 500 example.

The control flow 600 can include comparing 610 the GV 620 to the grant history vector (GHV) 630. Recall that the GV can be a one-hot encoding of the bus request, where the single asserted bit in the GV can be associated with a bus device that had been granted access to the common bus. Recall also that the GHV can be a copy of the previous GV bus grant request and is likewise one-hot encoded where the single asserted bit in the GHV can be associated with a bus device that was previously granted access to the common bus. The control flow 600 can include adjusting 670 a count grant (CG) 640, wherein the count grant indicates a number of times that the bus requester indicated by the GHV was granted successive accesses to the common bus. In embodiments the CG is incremented depending on the comparison of GV and GHV. In other embodiments the CG is reset to “1” decimal depending on the comparison of GV and GHV.

In embodiments, the adjusting includes incrementing 650 the CG, wherein the GV matches the GHV. If the GV matches the GHV, bit for bit, it can indicate that the present bus grant can be a successor of the previous bus grant. The bus device that was granted access to the common bus can be the same bus device that was previously granted access to the common bus with no intervening other bus device being granted access to the common bus between grants. In the control flow 600 example, the CG was set to “1” decimal, which can indicate that there had been one previous access granted to the current bus requester. In the example of 600, the CG is incremented 650 to “2” decimal 670, which can indicate that there are now two bus grants for the current bus requester. In embodiments, the adjusting can include setting the CG to 1, wherein the GV does not match the GHV. If the GV does not match the GHV, bit for bit, it can indicate that the present bus grant can be the first bus grant for the current bus requester. It can indicate that the bus grant is not an immediate successor of a previous bus grant to the same bus requester. In the control flow 600 example, CG is set to “1” decimal 660.

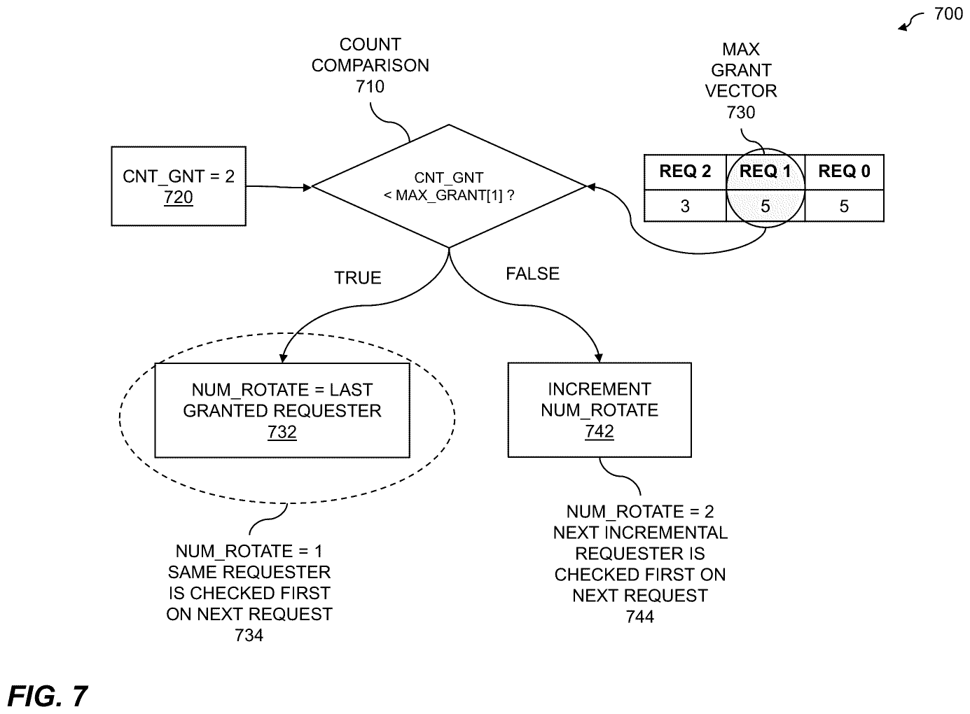

FIG. 7 is a fourth control flow diagram for granting a requester with a weighted incrementing function. The control flow 700 example is a continuation of the control flow 600 example. The disclosed technique can keep track of the number of successive bus grants for a particular bus requester so that a predefined maximum number of successive bus grants to a particular bus requester is not exceeded when at least one other bus requester requests access to the common bus. This can help maintain fair access to a common bus provided for one or more requesters that can prevent a single requester from dominating bus access. After a bus device is granted access, the CG can be adjusted to indicate the number of successive bus grants to a particular bus requester.

The control flow 700 can include comparing 710 the CG 720 to a maximum count, wherein the maximum count comprises a value in the MGV 730 associated with the bus requester indicated by the GV. In embodiments, the MGV can contain a value associated with each bus requester in the plurality of bus requesters. Additional embodiments include initializing the MGV. In other embodiments, the initializing occurs on a reset. In the control flow 700 example, bus requester 0 can be initialized to a maximum of five successive bus accesses, bus requester 1 can be initialized to a maximum of five successive bus accesses, and bus requester 2 can be initialized to a maximum of three bus successive bus accesses. In the control flow 500 example, bus access had been granted to bus requester 1. Carrying that example forward, in control flow 700, the MGV 730 that is associated with bus requester 1 is “5” decimal. In the control flow 600 example, the CG was incremented 650 to “2” decimal 670 which can indicate that there were two bus grants for the current bus requester. In the control flow 700 example, the CG 720 is compared to the MGV 730 associated with the current bus requester. The result of the comparison in this example indicates that the CG 720 is less than the MGV 730.

The control flow 700 can include setting the rotate value to the last granted requester 732, wherein the CG 720 is less than the maximum count. Recall from previous examples that the last granted requester was bus requester 1. In the control flow 700 example, the comparison is true, and the rotate value can be set to “1” which means that the same bus requester will be checked first on the next bus request 734. In embodiments, the comparing is based on an incrementing function. The control flow 700 can include incrementing the rotate value 742, wherein the CG 720 is not less than the maximum count. Recall from previous examples that the last granted requester was bus requester 1. In the example, if the comparison had been false, the rotate value would be incremented to “2” which means that the next incremental bus requester will be checked first on the next bus request 744 rather than the present bus requester.

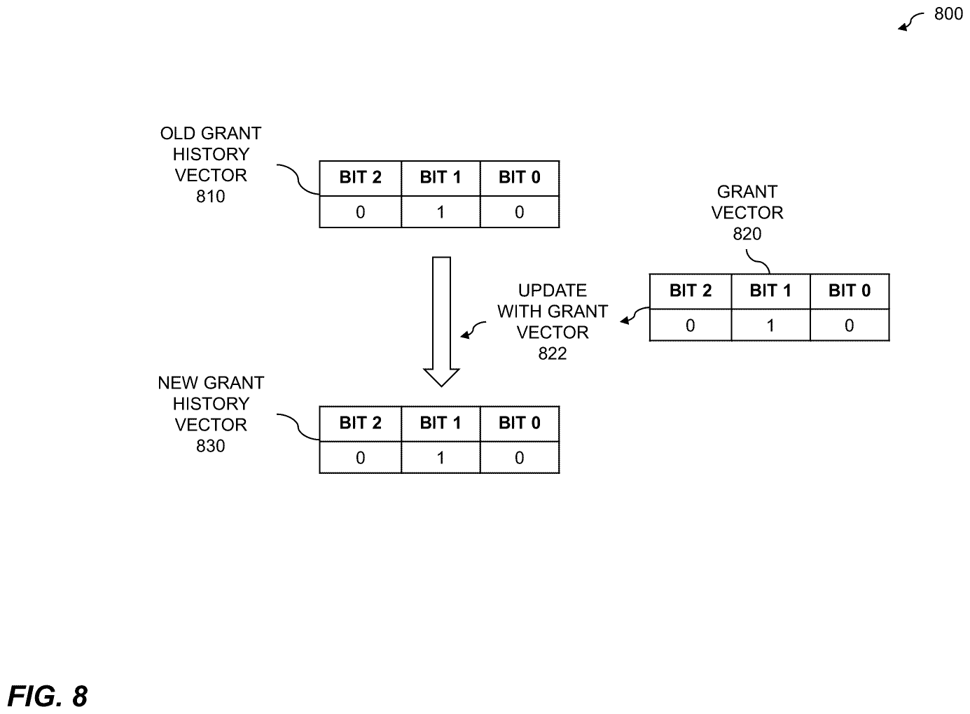

FIG. 8 is a control flow diagram to update a grant history vector. Recall that the GV can be a one-hot encoding of the bus request, where the single asserted bit in the GV can be associated with a bus device that had been granted access to the common bus. Recall also that the GHV can be a copy of the previous GV and can likewise be one-hot encoded where the single asserted bit in the GHV can be associated with a bus device that was last granted access to the common bus.

In the control flow 800 example, the GHV 810 from the last bus grant was “010”. In the example, the GV 820 contains “010”. The single bit position that is “1” is associated with bus requester 1 among bus requesters 0, 1, and 2. The arbitration logic therefore last allowed bus access to bus requester 1. The GHV can be one-hot encoded. The one-hot encoding can be useful because the state of the word can be immediately known without the need for a binary decode operation. One-hot encoding can be useful for fast processing of logical and other functions.

In the control flow 800 example, the GV 820 contains “010”. The bit position that is “1” is associated with bus requester 1 among bus requesters 0, 1, and 2. The arbitration logic therefore last allowed bus access on the common bus to bus requester 1. Embodiments include saving the GV to a GHV 822, wherein the GHV indicates a last granted requester within the plurality of bus requesters. The current grant vector can be saved so that the identity of the last bus grant can be known by the disclosed technique. After saving the GV, the GHV can contain the contents of the GV. In the control flow 800 example, the GV contained “010” so the GHV 830 can now contain “010”. The GHV can be factored into subsequent bus grant decisions so the arbitration logic can maintain fair access to the common bus by one or more bus requesters where a single bus requester cannot gain bus access beyond a predefined limit if at least one other bus requester has an outstanding request for the bus.

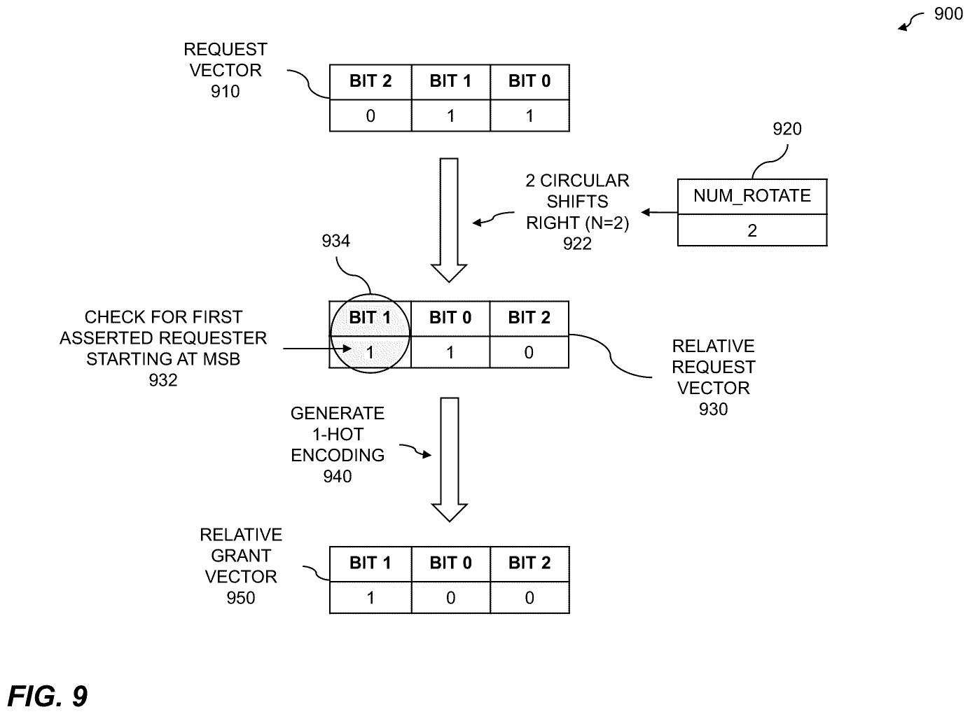

FIG. 9 is a first control flow diagram for granting a requester with a weighted decrementing function. Recall that one or more requesters can request access to the common bus. There can be simultaneous requests for access by the one or more requesters. A bus request can be retained for use in bus arbitration. Recall that the one or more bus requests can be stored in a request vector (RV). An RV can comprise one or more bits and can be implemented in software, hardware, or both. An RV can be located in on-chip register space, on-chip memory space, external memory space, and so on. An RV can have each bit of its one or more bit positions assigned to a requesting device. In a usage example, a common bus can be coupled to four processor cores and a memory element. In this case, the RV can include four bits. The first bit can be the rightmost bit of the four bits and can be a least significant bit (LSB). The LSB can be assigned to a first processor. The next bit to the left, the second bit, can be assigned to a second processor. The third and fourth bits can be assigned other processor cores. In this usage example, the first processor can execute instructions that can require access to the memory element on the common bus. As a result, the first bit in the RV can contain a “1”. If the second CPU also requires access to the memory through the common bus, the second bit in the RV can also contain a “1”. The RV can be an input signal that can be used by disclosed embodiments to coordinate and grant access to requesting devices to the common bus.

The control flow 900 includes requesting, by at least one bus requester, access to the common bus, wherein the requesting is stored in a request vector (RV) 910. In the control flow 900 example, the RV is three bits in length where the leftmost bit, bit 2, can be the most significant bit (MSB) and the rightmost bit, bit 0, can be the least significant bit (LSB). In the example, bit 0 contains a “1” which can mean that bus device 0 has requested access to the common bus. Bus device 0 can be a first processor core or another requesting device. Also in this example, bit 1 contains a “1” which can mean that bus device 1 has requested access to the common bus. Bus device 1 can be a second processor core or another requesting device. And finally in this example, bit 2 contains a “0” which can mean that bus device 2 has not requested access to the common bus. Bus device 2 can be a third processor core or another requesting device.

The control flow 900 includes a rotate value 920. The rotate value can be used to determine which bus requester of the plurality of bus requesters to the common bus will be given first access on the next request-grant cycle. As discussed previously, the rotate value can be used in combination with an increment function or a decrement function. The rotate value can be updated at the end of each request-grant cycle and can be based on the MGV which can be further based on a specified maximum number of successive bus accesses. In the control flow 900 example, the rotate value is set to “2” decimal.

The control flow 900 includes generating a relative request vector (RRV), wherein the generating is based on performing, on the RV, N circular shifts 922 in a right direction, wherein N is based on a rotate value. Because the rotate value is set to “2” in the control flow 900 example, N=2, and two circular shifts are performed on the RV 910. In the example, the circular shifts to the right result in moving bit 2, the MSB and the bit position assigned to bus requester 2, two bits to the right in the RRV 930. The two circular shifts to the right also result in moving bit 1, the bit position assigned to bus requester 1, two bits to the right in the RRV 930 which rolls it around to the MSB. The two circular shifts to the right also result in moving bit 0, the LSB and the bit position assigned to bus requester 0, two bits to the right which rolls it around through the MSB to bit 1 in the RRV 930. The bus request states of each of the three bus requesters move to the new bit positions in the RRV. Thus, the RRV 930 can now be two bits circular shifted relative to the RV 910.

The control flow 900 includes examining 932 a first asserted bit within the RRV, wherein the examining begins at a first bit position within the RRV, wherein the examining proceeds in a first direction. In embodiments, the examining can be based on a decrementing function. In additional embodiments, the first bit position is a most significant bit position. In further embodiments, the first direction is to the right. Thus, the search for a first asserted bit, a “1”, in the RRV can begin at the most significant bit and can proceed in a right direction. In the control flow 900 example, the examining 932 found an asserted bit 934, a “1”, at the most significant bit position of the RRV 930.

The control flow 900 includes creating a relative grant vector (RGV), wherein the RGV is based on the first asserted bit within the RRV, wherein the RGV comprises a one-hot encoding 940. In the control flow 900 example, the RRV contains “110” where the leftmost “1” is the first asserted bit 934. The one-hot encoding of the RRV can be “100” and can become the RGV 950. In the example, the RGV 950 contains a “1” at the bit position of the first asserted bit found by examination 932. The bit position that is “1” is associated with bus requester 1 among bus requesters 0, 1, and 2. In the example, bus requester 1 was associated with the first asserted bit and can be therefore identified as the bus requester to be granted access to the common bus. As with the RRV 930, the RGV 950 bit associations are relative, based on the circular shifting 922 previously done to the RRV.

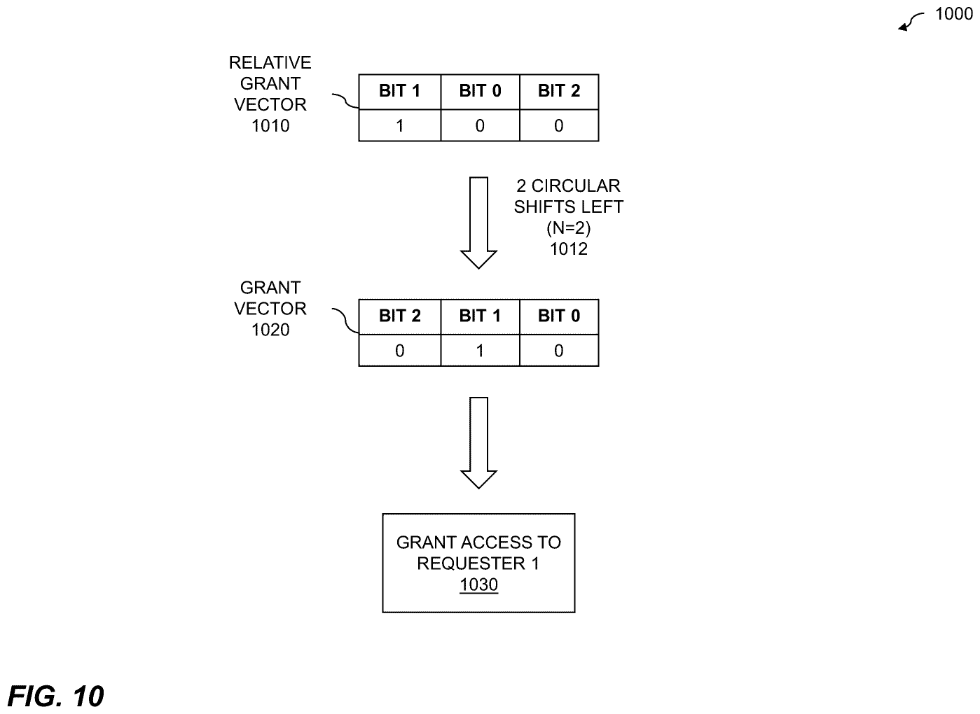

FIG. 10 is a second control flow diagram for granting a requester with a weighted decrementing function. The control flow 1000 example is a continuation of the control flow 900 example. In embodiments, the RGV 1010 is one-hot encoded. In the control flow 1000 example, the RGV contains “100”. The single bit position that is set to “1” is associated with bus requester 1 among bus requesters 0, 1, and 2. The RGV 1010 bit associations are relative due to the one or more previous circular shifts. Because of the relative placement in the RGV, bus requester 1 is not yet in its proper position to be useful as a grant vector. Circular bit shifting is employed to move it to its proper position in the GV, essentially undoing the circular shifting previously done to the RV.

The control flow 1000 includes producing a grant vector (GV), wherein the producing includes executing, on the RGV 1010, N circular shifts 1012 in a left direction. Recall in the control flow 900 example, the rotate value was set to “2” decimal, so N=2. In the control flow 1000 example, two circular shifts 1012 to the left are performed on the RGV. In the example, the two circular shifts to the left result in moving bit 2, the LSB of the RGV, and the bit position presently associated with bus requester 2, two bits to the left in the GV 1020. This places the state of bus requester 2 at physical bit 2 of the GV. The two circular shifts to the left also result in moving bit 0 of the RGV, the bit position associated with bus requester 0, two bits to the left in the GV 1020. This places the state of bus requester 0 at physical bit 0 of the GV. The two circular shifts to the left also result in moving bit 1, the MSB, and the bit position assigned to bus requester 1, two bits to the left which rolls it around through the LSB in the GV 1020. This places the state of bus requester 1 at physical bit 1 of the GV. Thus, the GV can be right-reading, where bit 0 is the request state of bus device 0, bit 1 is the request state of bus device 1, and bit 2 is the request state of bus device 2. In the example the GV 1020 contains “010”. The single bit position that is “1” is associated with bus requester 1 among bus requesters 0, 1, and 2.

The control flow 1000 includes granting access, by the arbitration logic, of the common bus, to a bus requester indicated by the GV. In the control flow 1000 example, the GV 1020 contains “010”. The bit position that is “1” is associated with bus requester 1 among bus requesters 0, 1, and 2. The arbitration logic therefore can grant bus access to bus requester 1 1030. The GV is one-hot encoded. One-hot encoding can be useful because the state of the word can be immediately known without the need for a binary decode operation. One-hot encoding can be useful for fast processing of logical and other functions.

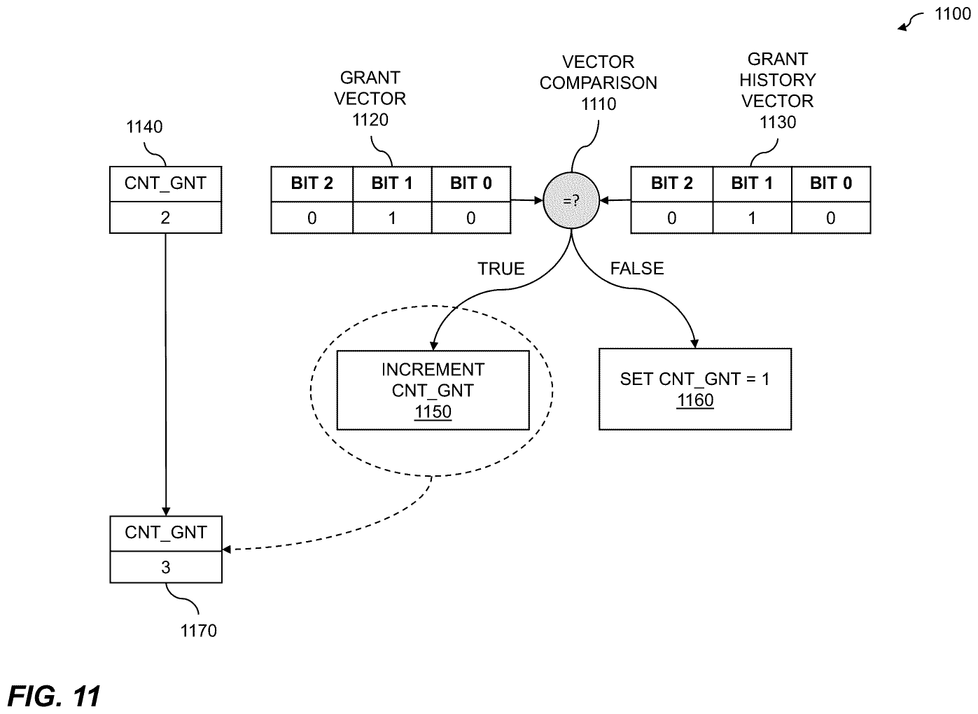

FIG. 11 is a third control flow diagram for granting a requester with a weighted decrementing function. The control flow 900 and the control flow 1000 illustrate how the selection of the next bus requester can be accomplished. After the selection is accomplished and bus access is granted, the disclosed technique can determine the number of successive bus accesses have been granted to a single bus requester of the common bus. The control flow 1100 example is a continuation of the control flow 1000 example.

The control flow 1100 can include comparing 1110 the GV 1120 to the grant history vector (GHV) 1130. Recall that the GV can be a one-hot encoding of the bus request, where the single asserted bit in the GV can be associated with a bus device that had been granted access to the common bus. Recall also that the GHV can be a copy of the previous GV bus grant request and is likewise one-hot encoded, where the single asserted bit in the GHV can be associated with a bus device that was previously granted access to the common bus.

The control flow 1100 can include adjusting a count grant (CG) 1140, wherein the count grant indicates a number of times that the bus requester indicated by the GHV was granted successive accesses to the common bus. In embodiments the CG is incremented depending on the comparison of GV and GHV. In other embodiments the CG is reset to “1” decimal depending on the comparison of GV and GHV.

The control flow 1100 can include adjusting that includes incrementing 1150 the CG, wherein the GV matches the GHV. If the GV matches the GHV, bit for bit, it can indicate that the present bus grant can be a successor of the previous bus grant. The bus device that was granted access to the common bus can be the same bus device that was previously granted access to the common bus with no intervening other bus device being granted access to the common bus between grants. In the control flow 1100 example, CG 1140 was set to “2” decimal which can indicate that there had been two previous accesses granted to the current bus requester. In the example, the CG is incremented 1150 to “3” decimal 1170 which can indicate that there are now three bus grants for the current bus requester.

The control flow 1100 can include adjusting that includes setting the CG to 11160, wherein the GV 1120 does not match the GHV 1130. If the GV does not match the GHV, bit for bit, it can indicate that the present bus grant can be the first bus grant for the current bus requester. It can indicate that the bus grant is not an immediate successor of a previous bus grant to the same bus requester. In the control flow 1100 example, CG is set to “1” decimal 1160.

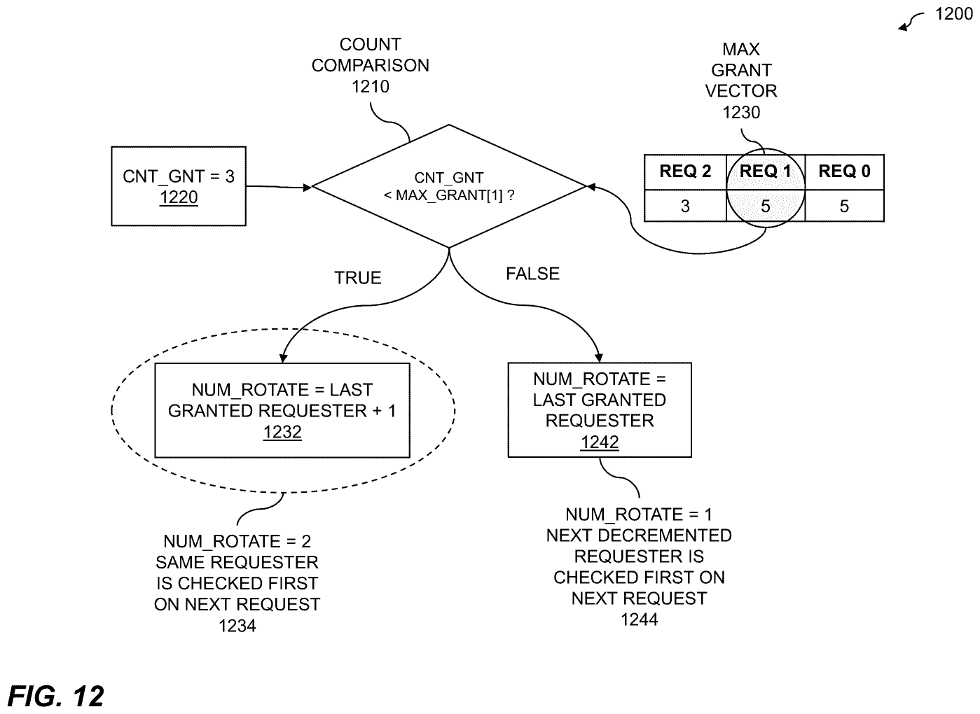

FIG. 12 is a fourth control flow diagram for granting a requester with a weighted decrementing function. The control flow 1200 example is a continuation of the control flow 1100 example. The disclosed technique can keep track of the number of successive bus grants for a particular bus requester so that a predefined maximum number of successive bus grants to a particular bus requester is not exceeded when at least one other requester requests access to the common bus. This can help maintain fair access to a common bus provided for one or more requesters that can prevent a single requester from dominating bus access. After a bus device is granted access, the CG can be adjusted to indicate the number of successive bus grants to a particular bus requester.

The control flow 1200 can include comparing 1210 the CG 1220 to a maximum count, wherein the maximum count comprises a value in the MGV 1230 associated with the bus requester indicated by the GV 1120. In embodiments, the MGV can contain a value associated with each bus requester in the plurality of bus requesters. Additional embodiments include initializing the MGV. In other embodiments, the initializing occurs on a reset. In the control flow 1200 example, bus requester 0 can be initialized to a maximum of five successive bus accesses, bus requester 1 can be initialized to a maximum of five successive bus accesses, and bus requester 2 can be initialized to a maximum of three bus successive bus accesses. In the control flow 1000 example, bus access had been granted to bus requester 1. Carrying that example forward, in control flow 1200 the MGV 1230 that is associated with bus requester 1 is “5” decimal. In the control flow 1100 example, the CG was incremented 1150 to “3” decimal which can indicate that there were three bus grants for the current bus requester. In the control flow 1200 example, the CG 1220 is compared to the MGV 1230 associated with the current bus requester. The result of the comparison in this example indicates that the CG 1220 is less than the MGV 1230.

The control flow 1200 can include advancing the rotate value to the last granted requester plus 1, wherein the CG is less than the maximum count. Recall from previous examples that the last granted requester was bus requester 1. In the control flow 1200 example, when the comparison is true 1232, and the rotate value can be set to “2”, which means that the same bus requester will be checked first on the next bus request 1234. In embodiments, the comparing is based on a decrementing function. In the control flow 1200 example, when the comparison is false 1242, the rotate value can be revised to the last granted requester. Recall from previous examples that the last granted requester was bus requester 1. In the example, if the comparison had been false, the rotate value would be decremented to “1” which means that the next decremental bus requester will be checked first on the next bus request 1244 rather than the present bus requester.

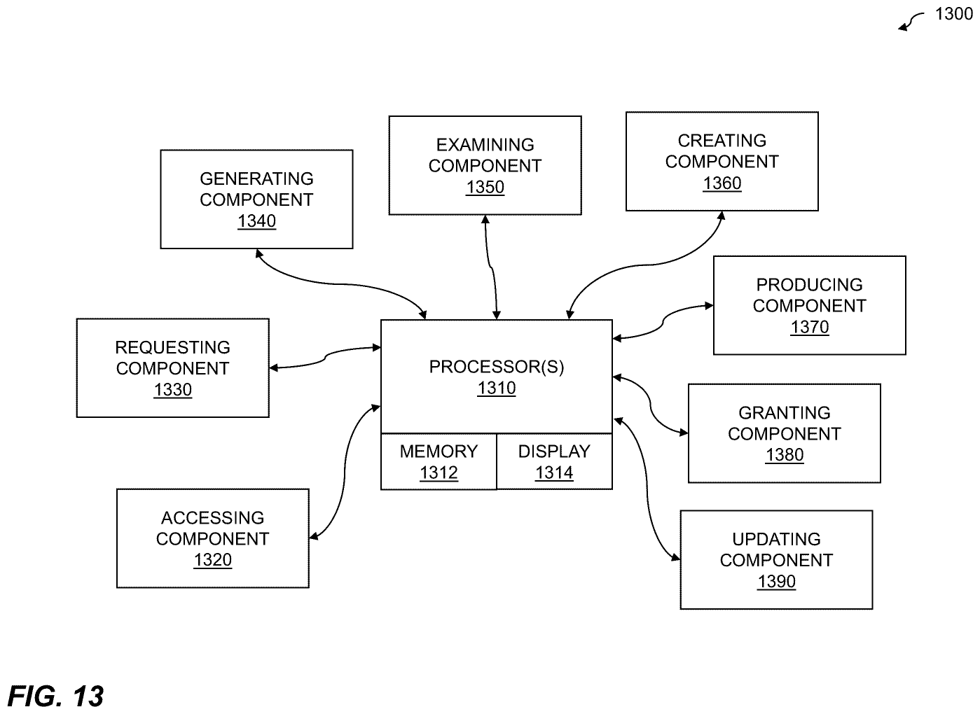

FIG. 13 is a system diagram for weighted round robin bus arbitration with control vectors and increment and decrement functions. The purpose of the disclosed technique is to enable and provision the process of fast bus arbitration. It employs a round robin strategy with circular shifting that allows the use of combinatorial logic alone that executes in one cycle. The system 1300 comprises a system that can contain one or more processors 1310 or processor cores. The one or more processors or processor cores can include processors on-chip, in system-on-a-chip (SOC) processors, cores that are embedded in application specific integrated circuits (ASICs), soft processors that are implemented in an FPGA chip, and so on. The one or more processors 1310 can be coupled to a memory 1312. Memories can be one or more storage units such as volatile and non-volatile semiconductor memories, cache memory structures, main memory, secondary memory, and more. The one or more processors 1310 can be coupled to a display 1314 and other human interface devices (HID) such as a keyboard. HIDs can include a video display that displays operational status of system functionality, operating data, and other parameters. A video display can be used as a debug tool for displaying bus performance, system status, and so on. The processor(s), the memory, and the display can reside in multiple and disparate networked locations, or can reside in a single location implemented as a laptop computer, desktop computer, etc.

The system 1300 includes an accessing component 1320. Embodiments include accessing a plurality of bus requesters, wherein the plurality of bus requesters is coupled to a common bus by an arbitration logic. Requests are made by a plurality of devices on the bus that requests access to the bus. Access can include memory access, CPU core access, and so on. The devices are coupled to a common bus by an arbitration logic. Connected bus requesters can include one or more devices that need to access one or more memories, one or more processors, one or more input/output devices, and so on. Common buses can include buses that are internal or external to a computer system. In embodiments, the common bus comprises a PCI-E bus. In further embodiments the common bus comprises a compute express link (CXL) bus. In other embodiments, the common bus comprises an Ethernet bus. In additional embodiments, the common bus comprises a universal serial bus (USB). A common bus can comprise other high speed bus structures and protocols. Arbitration logic in disclosed embodiments can coordinate accesses to the common bus by the various bus requesters. Arbitration logic can be implemented in software, hardware, or a combination of the two. Arbitration logic can be implemented as a single centralized logic structure that performs bus arbitration across the entire set of connected bus requesters. Arbitration logic can also be implemented as a distributed system of logic that includes the connected bus requesters in the arbitration process. The arbitration logic can comprise a state machine.

The system 1300 includes a requesting component 1330. Embodiments include requesting, by at least one bus requester, access to the common bus, wherein the requesting is stored in a request vector (RV). A bus requester can request access to the common bus. One or more requesters can request access to the common bus at the same time. A bus request can be stored in a request vector (RV). An RV can comprise one or more bits. An RV can include each bit of the one or more bits associated with a requesting device. A requesting device that requires access to the common bus will make the bit active at its assigned bit position in the RV. The RV can be an input signal that can be used by the disclosed technique to coordinate and grant access for the requesting device to the common bus.

The system 1300 includes a generating component 1340. Embodiments include generating a relative request vector (RRV), wherein the generating is based on performing, on the RV, N circular shifts in a right direction, wherein N is based on a rotate value. In embodiments, the rotate value is initialized upon reset. In other embodiments, the rotate value is updated later after each bus grant with an appropriate number of circular shifts. The disclosed technique can utilize one or more circular shifts of the RV in the creation of a relative copy of the vector, hence RRV. The circular shifts are employed in the disclosed process for identifying and isolating the bus device that will be the next device granted access to the common bus. The bus device can be one or more processors or processor cores that can include processors on-chip, in system-on-a-chip (SOC) processors, cores that are embedded in application specific integrated circuits (ASICs), soft processors that are implemented in an FPGA chip, and so on.

The system 1300 includes an examining component 1350. Embodiments include examining a first asserted bit within the RRV, wherein the examining begins at a first bit position within the RRV, wherein the examining proceeds in a first direction. The first asserted bit can be the identified priority request that needs to be granted by the disclosed technique. It will be seen that this bit will be carried through the process steps and isolated in a final grant vector by the disclosed technique. The disclosed technique starts examining at one end of the RRV and proceeds, bit by bit, to discover the first asserted bit. As previously described, the disclosed technique can be accomplished by an incrementing function or a decrementing function. In embodiments, for an incrementing function, the first bit position is a least significant bit position. In further embodiments, for an incrementing function, the first direction is left. In embodiments, for a decrementing function, the first bit position is a most significant bit position. In further embodiments, for a decrementing function, the first direction is right.

The system 1300 includes a creating component 1360. Embodiments include creating a relative grant vector (RGV), wherein the RGV is based on the first asserted bit within the RRV, wherein the RGV comprises a one-hot encoding. The first asserted bit within the RRV can control which bus requester is first in line for access to the common bus. The RRV can have one or more bits, each of which can be associated with a bus device. An asserted bit in the RRV can identify a bus device that has requested access to the common bus. There can be one or more bits asserted simultaneously. An RGV can be created from the RRV by making the first asserted bit the sole bit, hence one-hot, that is asserted in the RGV. The single asserted bit identifies the bus requester that has requested access, but the single asserted bit is still in a relative position.

The system 1300 includes a producing component 1370. Embodiments include producing a grant vector (GV), wherein the producing includes executing, on the RGV, N circular shifts in a left direction. The one-hot RGV can be circular shifted N number of times in a left direction, which effectively reverses the circular shifting that was done in the generating step. The GV that is produced has the single asserted bit aligned in the grant vector to identify the bus device that will be granted access to the common bus. Further embodiments comprise storing the GV as a new GHV. Because the GV is one-hot encoded, the new GHV can also be one-hot encoded and can be thus prepared for the next bus request and subsequent checking a GHV.

The system 1300 includes a granting component 1380. Embodiments include granting access, by the arbitration logic, of the common bus to a bus requester indicated by the GV. Recall that bus requests can come from one or more devices connected to a common bus. The common bus can comprise a PCI-E bus, CXL bus, Ethernet, USB, and so on. A single connected device will have access to the common bus due to this bus granting. Access can be granted with combinatorial logic, hardware circuitry, or a combination of the two. In embodiments, the requesting, the generating, the examining, the creating, the producing, the granting, the updating, and the saving occur in a single clock cycle. In other embodiments, the requesting, the generating, the examining, the creating, the producing, the granting, the updating, and the saving are implemented in combinatorial logic.

The system 1300 includes an updating component 1390. Embodiments include updating the rotate value, wherein the updating is based on a maximum grant vector (MGV), wherein the MGV specifies a maximum number of times each bus requester is allowed successive accesses to the common bus. Embodiments include adjusting a count grant (CG), wherein the count grant indicates a number of times that the bus requester indicated by the GHV was granted successive accesses to the common bus. The GV that was used in the granting can be compared to the GHV. If the GV and the GHV match, it reveals that this grant was another in a series of successive grants to the same bus device, and the CG can be incremented. If the GV and the GHV do not match, it reveals that this grant was the first grant to this bus device, and the CG can be reset to “1”. The updating component 1390 also compares the CG to a maximum value in the MGV that is associated with the bus device. As previously described, the disclosed technique can be accomplished by an incrementing function or a decrementing function. In embodiments, for an incrementing function, the rotate value can be set to the last granted requester if the CG is less than the maximum value. It will be seen that this can allow the next access grant to the same bus device. In other embodiments, for an incrementing function, the rotate value can be incremented to the next incremental requester if the CG is not less than the maximum value. It will be seen that this can allow the next access grant to the next bus device. In embodiments, for a decrementing, the rotate value can be set to the last granted requester plus 1 if the CG is less than the maximum value. It will be seen that this can allow the next access grant to the same bus device. In other embodiments, for a decrementing function, the rotate value can be set to the last granted requester if the CG is not less than the maximum value. It will be seen that this can allow the next access grant to the next bus device.

The system 1300 can include a computer program product embodied in a non-transitory computer readable medium for resource sharing, the computer program product comprising code which causes one or more processors to generate semiconductor logic for: accessing a plurality of bus requesters, wherein the plurality of bus requesters is coupled to a common bus by an arbitration logic; requesting, by at least one bus requester, access to the common bus, wherein the requesting is stored in a request vector (RV); generating a relative request vector (RRV), wherein the generating is based on performing, on the RV, N circular shifts in a right direction, wherein N is based on a rotate value; examining a first asserted bit within the RRV, wherein the examining begins at a first bit position within the RRV, wherein the examining proceeds in a first direction; creating a relative grant vector (RGV), wherein the RGV is based on the first asserted bit within the RRV, wherein the RGV comprises a one-hot encoding; producing a grant vector (GV), wherein the producing includes executing, on the RGV, N circular shifts in a left direction; granting access, by the arbitration logic, of the common bus, to a bus requester indicated by the GV; and updating the rotate value, wherein the updating is based on a maximum grant vector (MGV), wherein the MGV specifies a maximum number of times each bus requester is allowed successive accesses to the common bus.

The system 1300 can include a computer system for resource sharing comprising: a memory which stores instructions; one or more processors coupled to the memory wherein the one or more processors, when executing the instructions which are stored, are configured to: access a plurality of bus requesters, wherein the plurality of bus requesters is coupled to a common bus by an arbitration logic; request, by at least one bus requester, access to the common bus, wherein the requesting is stored in a request vector (RV); generate a relative request vector (RRV), wherein the generating is based on performing, on the RV, N circular shifts in a right direction, wherein N is based on a rotate value; examine a first asserted bit within the RRV, wherein the examining begins at a first bit position within the RRV, wherein the examining proceeds in a first direction; create a relative grant vector (RGV), wherein the RGV is based on the first asserted bit within the RRV, wherein the RGV comprises a one-hot encoding; produce a grant vector (GV), wherein the producing includes executing, on the RGV, N circular shifts in a left direction; grant access, by the arbitration logic, of the common bus, to a bus requester indicated by the GV; and update the rotate value, wherein the updating is based on a maximum grant vector (MGV), wherein the MGV specifies a maximum number of times each bus requester is allowed successive accesses to the common bus.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the abovementioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A processor-implemented method for resource sharing comprising:
accessing a plurality of bus requesters, wherein the plurality of bus requesters is coupled to a common bus by an arbitration logic;
requesting, by at least one bus requester, access to the common bus, wherein the requesting is stored in a request vector (RV);
generating a relative request vector (RRV), wherein the generating is based on performing, on the RV, N circular shifts in a right direction, wherein N is based on a rotate value;
examining a first asserted bit within the RRV, wherein the examining begins at a first bit position within the RRV, wherein the examining proceeds in a first direction;
creating a relative grant vector (RGV), wherein the RGV is based on the first asserted bit within the RRV, wherein the RGV comprises a one-hot encoding;
producing a grant vector (GV), wherein the producing includes executing, on the RGV, N circular shifts in a left direction;
granting access, by the arbitration logic, of the common bus, to a bus requester indicated by the GV; and
updating the rotate value, wherein the updating is based on a maximum grant vector (MGV), wherein the MGV specifies a maximum number of times each bus requester is allowed successive accesses to the common bus.

2. The method of claim 1 further comprising comparing the GV to a grant history vector (GHV).

3. The method of claim 2 wherein the GHV comprises a number of bits, wherein the number of bits is equal to a number of bus requesters in the plurality of bus requesters.

4. The method of claim 2 further comprising adjusting a count grant (CG), wherein the count grant indicates a number of times that the bus requester indicated by the GHV was granted successive accesses to the common bus.

5. The method of claim 4 wherein the adjusting includes incrementing the CG, wherein the GV matches the GHV.

6. The method of claim 5 wherein the adjusting includes setting the CG to 1, wherein the GV does not match the GHV.

7. The method of claim 5 further comprising comparing the CG to a maximum count, wherein the maximum count comprises a value in the MGV associated with the bus requester indicated by the GV.

8. The method of claim 7 wherein the comparing is based on an incrementing function.

9. The method of claim 8 further comprising setting the rotate value to the last granted requester, wherein the CG is less than the maximum count.

10. The method of claim 9 further comprising incrementing the rotate value, wherein the CG is not less than the maximum count.

11. The method of claim 7 wherein the comparing is based on a decrementing function.

12. The method of claim 11 further comprising advancing the rotate value to the last granted requester plus 1, wherein the CG is less than the maximum count.

13. The method of claim 12 further comprising revising the rotate value to the last granted requester, wherein the CG is not less than the maximum count.

14. The method of claim 1 further comprising saving the GV to a grant history vector (GHV), wherein the GHV indicates a last granted requester within the plurality of bus requesters.

15. The method of claim 14 wherein the requesting, the generating, the examining, the creating, the producing, the granting, the updating, and the saving occur in a single clock cycle.

16. The method of claim 14 wherein the requesting, the generating, the examining, the creating, the producing, the granting, the updating, and the saving are implemented in combinatorial logic.

17. The method of claim 1 wherein the examining is based on an incrementing function.

18. The method of claim 17 wherein the first bit position is a least significant bit position.

19. The method of claim 18 wherein the first direction is to the left.

20. The method of claim 1 wherein the examining is based on a decrementing function.

21. The method of claim 20 wherein the first bit position is a most significant bit position.

22. The method of claim 21 wherein the first direction is to the right.

23. The method of claim 1 wherein the last granted requester comprises a bus requester in the plurality of bus requesters which was granted a most recent access to the common bus.

24. A computer program product embodied in a non-transitory computer readable medium for resource sharing, the computer program product comprising code which causes one or more processors to generate semiconductor logic for:
accessing a plurality of bus requesters, wherein the plurality of bus requesters is coupled to a common bus by an arbitration logic;
requesting, by at least one bus requester, access to the common bus, wherein the requesting is stored in a request vector (RV);
generating a relative request vector (RRV), wherein the generating is based on performing, on the RV, N circular shifts in a right direction, wherein N is based on a rotate value;
examining a first asserted bit within the RRV, wherein the examining begins at a first bit position within the RRV, wherein the examining proceeds in a first direction;
creating a relative grant vector (RGV), wherein the RGV is based on the first asserted bit within the RRV, wherein the RGV comprises a one-hot encoding;
producing a grant vector (GV), wherein the producing includes executing, on the RGV, N circular shifts in a left direction;
granting access, by the arbitration logic, of the common bus, to a bus requester indicated by the GV; and
updating the rotate value, wherein the updating is based on a maximum grant vector (MGV), wherein the MGV specifies a maximum number of times each bus requester is allowed successive accesses to the common bus.

25. A computer system for resource sharing comprising:
a memory which stores instructions;
one or more processors coupled to the memory wherein the one or more processors, when executing the instructions which are stored, are configured to:
access a plurality of bus requesters, wherein the plurality of bus requesters is coupled to a common bus by an arbitration logic;
request, by at least one bus requester, access to the common bus, wherein the requesting is stored in a request vector (RV);
generate a relative request vector (RRV), wherein the generating is based on performing, on the RV, N circular shifts in a right direction, wherein N is based on a rotate value;
examine a first asserted bit within the RRV, wherein the examining begins at a first bit position within the RRV, wherein the examining proceeds in a first direction;
create a relative grant vector (RGV), wherein the RGV is based on the first asserted bit within the RRV, wherein the RGV comprises a one-hot encoding;
produce a grant vector (GV), wherein the producing includes executing, on the RGV, N circular shifts in a left direction;
grant access, by the arbitration logic, of the common bus, to a bus requester indicated by the GV; and
update the rotate value, wherein the updating is based on a maximum grant vector (MGV), wherein the MGV specifies a maximum number of times each bus requester is allowed successive accesses to the common bus.
